(19) United States
(12) Patent Application Publication
(10) Pub. No.: US 2025/0010283 A1
(43) Pub. Date: Jan. 9, 2025

(54) Test Chamber and Control Method

(71) Applicant: Weiss Technik GmbH, Reiskirchen (DE)

(72) Inventors: Yannik Zahrt, Rabenau (DE); Christian Haack, Marburg (DE); Johannes Teichmann, Geislingen (DE)

(21) Appl. No.: 18/763,022

(22) Filed: Jul. 3, 2024

(30) Foreign Application Priority Data
Jul. 7, 2023 (EP) 23184052.1

(51) Int. Cl. B01L 1/02; B01L 7/00

(52) U.S. Cl. CPC B01L 1/025; B01L 7/00; B01L 2200/141; B01L 2300/0681; B01L 2300/10; B01L 2300/1844; B01L 2300/1894

(57) ABSTRACT

A test chamber and a method for conditioning air in a test space thereof for receiving test material, the test space being configured to be sealed from an environment and temperature-insulated, a cooling device of a temperature control device of the test chamber, which comprises a cooling circuit with carbon dioxide as a refrigerant, a heat exchanger in the test space, a low-pressure compressor, and a high-pressure compressor, a gas cooler, and an expansion valve downstream of the low-pressure compressor in a flow direction of the refrigerant, being used to establish a temperature between −20° C. to +180° C. within the test space, a control device of the test chamber being used to control the temperature and/or a relative humidity in the test space. A dehumidifier bypass of the cooling circuit, which comprises a second expansion valve and a second heat exchanger, is used to dehumidify air in the test space.

### CROSS-REFERENCE TO RELATED APPLICATION

This application claims priority to European Patent Application No. 23184052.1 filed Jul. 7, 2023, the disclosure of which is incorporated herein by reference in its entirety for all purposes.

### TECHNICAL FIELD

The invention relates to a test chamber, in particular a climate chamber, for conditioning air and to a method for conditioning air in a test space of a test chamber, in particular a climate chamber, for receiving test material, the test space being configured to be sealed from an environment and temperature-insulated, a cooling device of a temperature control device of the test chamber, which comprises a cooling circuit with carbon dioxide as a refrigerant, a heat exchanger in the test space, a low-pressure compressor, and a high-pressure compressor, a gas cooler, and an expansion valve downstream of the low-pressure compressor in a flow direction of the refrigerant, being used to establish a temperature in a temperature range of −20° C. to +180° C. within the test space, a control device of the test chamber being used to control the temperature and/or a relative humidity in the test space.

### BACKGROUND

Test chambers of this kind are regularly used to test physical and/or chemical properties of objects, in particular devices. For example, there are known temperature test cabinets or climatic test cabinets within which temperatures in a range from −70° C. to +180° C. can be set. In the case of climatic test cabinets, desired climatic conditions can be additionally set, to which the device or the test material is then exposed over a defined period of time. The temperature of a test space containing the test material is regularly controlled in an air circulation duct within the test space. The air circulation duct forms an air treatment space in the test space, in which heat exchangers for heating or cooling the air flowing through the air circulation duct or the test space are disposed. A fan or a ventilator aspirates the air in the test space and guides it through the air circulation duct to the respective heat exchangers. The test material can thus be temperature-controlled or exposed to a defined change in temperature. During a test interval, the temperature can change, for example, between a maximum temperature and a minimum temperature of the test chamber. A test chamber of this kind is known from EP 0 344 397 A2, for example.

The refrigerant used in a cooling circuit should have a relatively low CO₂ equivalent, i.e., a relative global warming potential (GWP) should be as low as possible in order to avoid indirect damage to the environment by the refrigerant upon release. It is therefore also known for carbon dioxide (CO₂) to be used as a pure-substance refrigerant. Carbon dioxide is available at low cost, is non-flammable and is essentially environmentally neutral with a GWP of 1. Carbon dioxide has a freezing temperature or a triple point of −56.6° C., which makes it impossible to achieve lower temperatures with carbon dioxide alone.

Furthermore, there are known cooling devices which are configured as what is referred to as booster systems. In a cooling circuit of said cooling devices, a high-pressure compressor is always connected in series downstream of a low-pressure compressor, so the refrigerant is compressed in stages with the low-pressure compressor and then with the high-pressure compressor. Due to the high demands on temperature control within the temperature range of the test space, the load requirement frequently fluctuate during operation of the test chamber. Hence, the cooling capacity generated by the compressors and the expansion valve has to be infinitely variable. Nevertheless, it is desirable for the compressors to not be switched on and off frequently in order to extend the service life of the compressors.

Since carbon dioxide as a refrigerant has a very high volumetric cooling capacity, a very high cooling capacity is provided by the cooling circuit even when using compressors with a very low stroke volume flow. In addition, a pressure range of cooling circuits with carbon dioxide as the refrigerant is very high (up to 120 bar) in transcritical operation, which is why the components required to form the cooling circuit are comparatively expensive. Moreover, cooling circuits of this kind have a complex structure, which requires a large installation space. Up to now, the use of cooling circuits of this kind with carbon dioxide as the refrigerant has therefore only been sensible for systems or test chambers with a correspondingly high cooling capacity and thus a comparatively large test space or large device dimensions. Economic use in comparatively small systems or test chambers with a small test space volume, for example 25 liters, is not yet possible.

Due to the very high cooling capacity, there is also the problem that climatic tests can only be carried out to a limited extent. A defined relative humidity and temperature must be established in the test space. Among other things, this also requires dehumidification of the air in the test space, for example if the air in the test space is cooled down during a test cycle. When the air is cooled, condensation on the heat exchanger is difficult to control, in particular due to the high cooling capacity, which can lead to unwanted dehumidification of the air in the test space. Furthermore, dehumidification can also be too low if, for example, only a very slow, defined change in temperature is intended as part of a test cycle. Hence, a climatic test cycle cannot always be carried out with satisfactory accuracy using a cooling device of this kind. Features for conditioning air that are separate from the test space, for example systems that require an air exchange in the test space, are costly, energy-intensive and significantly enlarge the test chamber.

### SUMMARY

Hence, the object of the present invention is to propose a method for conditioning air in a test space of a test chamber and a test chamber which enables climatic tests to be carried out with a comparatively compact and technically simple configuration of the test chamber.

In the method according to the invention for conditioning air in a test space of a test chamber, in particular a climate chamber, for receiving test material, the test space being configured to be sealed from an environment and temperature-insulated, a cooling circuit of a temperature control device of the test chamber, which comprises a cooling circuit with carbon dioxide as a refrigerant, a heat exchanger in the test space, a low-pressure compressor, and a high-pressure compressor, a gas cooler, and an expansion valve downstream of the low-pressure compressor in a flow direction of the refrigerant, is used to establish a temperature in a temperature range of −20° C. to +180° C. within the test space, a control device of the test chamber being used to control the temperature and/or a relative humidity in the test space, wherein a dehumidifier bypass of the cooling circuit, which comprises a second expansion valve and a second heat exchanger in the test space, is used to dehumidify air in the test space.

In the method according to the invention, heat exchange with an environment of the test space is largely avoided by insulating the side walls, floor walls and ceiling walls. The heat exchanger is connected to the cooling circuit or integrated into it in such a manner that refrigerant circulating in the cooling circuit flows through the heat exchanger. The heat exchanger of the cooling circuit is disposed within the test space or in an air treatment space of the test space, so air in the test space is conditioned or temperature-controlled via the heat exchanger. The gas cooler is also integrated into the cooling circuit and is formed by a heat exchanger. The gas cooler is disposed downstream of the high-pressure compressor in the cooling circuit, the compressed refrigerant, which is under high pressure after compression and is essentially in gaseous or steam form or wet steam, being able to condense in the gas cooler or condenser and then essentially being in a liquid state of aggregation. It is also possible that the gaseous refrigerant does not condense in the gas cooler and leaves the gas cooler essentially in a gaseous state. The gas cooler or the heat exchanger in question can be equipped with means for cooling the refrigerant, for example with air or water. In particular, the gas cooler can be a water-cooled or air-cooled finned tube heat exchanger. In this case, the gas cooler can be particularly compact. The refrigerant flows from the gas cooler via the expansion valve, through which it becomes gaseous or steam again due to expansion as a result of a pressure drop. In the process, it flows through the heat exchanger, which is cooled as a result. Subsequently, the gaseous refrigerant is aspirated and compressed again by the low-pressure compressor and the high-pressure compressor.

According to the present invention, the dehumidifier bypass of the cooling circuit is configured to dehumidify air in the test space. This dehumidification can take place at a certain point during a test cycle, in particular whenever a temperature in the test space is within a range of >0 to <100° C. If a temperature within the test space is below or above this range, no water can precipitate on the second heat exchanger in the liquid phase, so the dehumidifier bypass does not function in these ranges. Accordingly, the cooling circuit of the cooling device is designed in such a manner that the temperature of −20° C. to +180° C. can be established within the test space during a test cycle, dehumidification of the air by means of the dehumidifier bypass being carried out only in a partial range of this temperature range. Dehumidification takes place by metering the refrigerant from a high-pressure side of the cooling circuit into a low-pressure side of the cooling circuit via the second expansion valve. This results in cooling of the second heat exchanger, which is disposed downstream in a flow direction of the refrigerant in the second expansion valve in the dehumidifier bypass. The control device can now meter the refrigerant via the second expansion valve in such a manner that a desired difference in temperature between the temperature of the air in the test space and the temperature of the second heat exchanger is achieved. This difference in temperature can be selected in such a manner that water from the air in the test space condenses on the second heat exchanger. This makes it possible for targeted dehumidification of the air of the test space to be carried out essentially independently of a temperature established in the test space. The expansion valve and the second expansion valve can thus be controlled independently of each other using the control device. A lowering of a temperature in the test space can then be accompanied, for example, by more or less dehumidification, whereby a relative humidity can be set or controlled more precisely. Overall, a climatic test cycle can be carried out much more accurately with just a few components in a compact test chamber.

The dehumidifier bypass can be connected to a high-pressure side of the cooling circuit downstream of the gas cooler and upstream of the expansion valve and to a low-pressure side of the cooling circuit downstream of the heat exchanger and upstream of the low-pressure compressor, and refrigerant can be metered from the high-pressure side into the low-pressure side via the second expansion valve in such a manner that the second heat exchanger is cooled. The second expansion valve can be an electronic expansion valve or a solenoid valve with a downstream throttle, for example through a capillary tube, a nozzle or the like, or a thermostatic expansion valve. Optionally, the dehumidifier bypass may also be connected downstream of any internal heat exchanger downstream of the gas cooler. The dehumidifier bypass can therefore be connected to the cooling circuit in parallel with the expansion valve and the heat exchanger. In this manner, the dehumidifier bypass can be of a particularly simple design.

A second bypass with at least a third expansion valve can be formed in the cooling circuit, and the second bypass can be connected to a high-pressure side of the cooling circuit downstream of the gas cooler and upstream of the expansion valve and to a low-pressure side of the cooling circuit downstream of the heat exchanger and upstream of the low-pressure compressor, and a suction-gas temperature and/or a suction-gas pressure of the refrigerant on the low-pressure side of the cooling circuit upstream of the low-pressure compressor can be controlled by metering refrigerant into the low-pressure side via the third expansion valve. Optionally, the second bypass may be connected to the high-pressure side downstream of an internal heat exchanger in the cooling circuit and downstream of the gas cooler. The third expansion valve can be used to influence the suction-gas temperature and/or the suction-gas pressure upstream of the low-pressure compressor in such a manner that a final compression temperature of the low-pressure compressor is within an operating range intended for the low-pressure compressor. For example, a suction-gas temperature of the low-pressure compressor can rise particularly sharply if a temperature in the test space is to be reduced, for example, from +180° C. to a lower temperature. Since the heat exchanger is located in the test space, the refrigerant, at particularly high temperatures in the test space of +180° C., for example, can flow from the heat exchanger to the low-pressure compressor at this temperature. Before the heavily overheated refrigerant is fed to the low-pressure compressor, it can be cooled by the refrigerant metered via the third expansion valve.

Another bypass having at least one other valve may be formed in the cooling circuit, and the other bypass may be connected to a high-pressure side of the cooling circuit downstream of the high-pressure compressor and upstream of the gas cooler and to a low-pressure side of the cooling circuit downstream of the heat exchanger and upstream of the low-pressure compressor, and a suction-gas temperature and/or a suction-gas pressure of the refrigerant on the low-pressure side of the cooling circuit upstream of the low-pressure compressor can be controlled and/or a difference in pressure between the high-pressure side and the low-pressure side of the cooling circuit can be equalized by metering refrigerant into the low-pressure side via the other valve. Accordingly, the other bypass is configured in such a manner that refrigerant can be fed from the high-pressure side to the low-pressure side via the other valve. The refrigerant can be superheated or gaseous. Returning superheated refrigerant from the high-pressure side to the low-pressure side by means of the other bypasses is advantageous in particular if the cooling circuit is operated in a partial-load operating state. As the expansion valve is opened only a little or rarely in this case, there is a risk that a suction pressure upstream of the low-pressure compressor drops too far. When using carbon dioxide as the refrigerant, dry ice can form at a pressure below 5.16 bar absolute, which could disrupt safe operation of the cooling circuit and possibly damage the low-pressure compressor. As highly superheated refrigerant can be fed directly downstream of the high-pressure compressor to a point upstream of the low-pressure compressor via the other bypass, the formation of dry ice can be effectively prevented. In addition, it is also possible to equalize a difference in pressure between the high-pressure side and the low-pressure side of the cooling circuit via the other bypass, for example when the cooling device is not in operation and there is a risk that refrigerant will be heated as a result of temperature equalization with an environment and an undesirably high pressure will build up in the cooling circuit.

A rotational speed of the high-pressure compressor and/or of the low-pressure compressor can be controlled. The high-pressure compressor and/or the low-pressure compressor can each be equipped with a frequency converter that allows the rotational speed of the compressors to be adjusted. By lowering the rotational speed, a mass flow of the refrigerant can be reduced further in a partial-load operating state of the cooling circuit, thus further increasing the efficiency of the cooling device in this operating state. Furthermore, a rotational speed control of the low-pressure compressor allows the rotational speed of the low-pressure compressor to be raised and lowered by the control device in such a manner that a suction-gas pressure on a low-pressure side of the cooling circuit can be changed and thus adjusted in a desired manner.

When the temperature in the test space is being increased or kept constant, a suction-gas pressure in a low-pressure side of the cooling circuit can be decreased, allowing a difference in temperature between the second heat exchanger and the test space to be increased. A suction-gas pressure in the low-pressure side can, for example, be established in a corresponding manner via a second bypass in the cooling circuit, another bypass in the cooling circuit and/or a controllable rotational speed of the low-pressure compressor if the cooling device has one. A difference in temperature between the second heat exchanger and the test space is increased here in particular by the fact that an evaporation temperature of the refrigerant is dependent on the suction-gas pressure on the low-pressure side. A reduction of the suction-gas pressures therefore leads to an increased difference in temperature between the second heat exchanger and the temperature in the test space. This is advantageous in particular when targeted dehumidification of the air in the test space is to be carried out, for example at a constant temperature in the test space. Overall, the cooling capacity of the dehumidifier bypass or of the second heat exchanger can be increased in this manner.

Furthermore, a difference in temperature between the heat exchanger and the test space can be increased in such a manner that air in the test space can be dehumidified. In addition to the second heat exchanger or the dehumidifier bypass, the heat exchanger can also be used to dehumidify the air in the test space. A cooling capacity that can be used for dehumidification can thus be maximized without the need for complex, additional components.

While lowering the temperature in the test space, a suction-gas pressure in a low-pressure side of the cooling circuit can be increased, and a difference in temperature between the second heat exchanger and the test space can be reduced. In this manner, the suction-gas pressure can be increased significantly, especially in the case of low cooling-load requirements, where the low-pressure compressor normally keeps the suction-gas pressure as low as possible in temperature operation. This can be done, for example, by means of a second bypass or by controlling the rotational speed of the low-pressure compressor. The suction-gas pressure can then be increased to such an extent that the suction-gas pressure enables dehumidification that is minimized as far as possible. As a result, the second heat exchanger can ice over less at suction-gas temperatures below 0° C., whereby the formation of an insulating layer of ice on the second heat exchanger can be completely avoided or reduced. The same applies to the heat exchanger, which is then also less prone to icing over due to the increased suction-gas temperature. It is also possible to reduce a difference in temperature between the heat exchanger or the second heat exchanger in the test space by increasing an effective heat exchanger surface area of the heat exchanger or of the second heat exchanger. However, this is disadvantageous if a high dehumidification capacity or rapid dehumidification of the air in the test space is required.

The cooling circuit can have a medium-pressure bypass, which is connected to a high-pressure side of the cooling circuit downstream of the gas cooler and upstream of the expansion valve and to a medium-pressure side of the cooling circuit upstream of the high-pressure compressor and downstream of the low-pressure compressor, in which case refrigerant can be metered from the high-pressure side into the medium-pressure side by means of the other expansion valve. The medium-pressure bypass can then be used to carry out what is referred to as medium-pressure injection of refrigerant into a line or a medium-pressure side connecting the low-pressure compressor to the high-pressure compressor. The refrigerant fed via the medium-pressure bypass can then be mixed with the refrigerant circulating in the cooling circuit in this location.

The cooling circuit can have an internal heat exchanger, which can be connected to a high-pressure side of the cooling circuit downstream of the gas cooler and upstream of the expansion valve, and the internal heat exchanger can be coupled to a medium-pressure bypass of the cooling circuit, and the medium-pressure bypass can be connected to the high-pressure side downstream of the internal heat exchanger upstream of the gas cooler and upstream of the expansion valve and to a medium-pressure side of the cooling circuit upstream of the high-pressure compressor and downstream of the low-pressure compressor, and refrigerant can be metered from the high-pressure side into the medium-pressure side via the internal heat exchanger by means of another expansion valve. Immediately downstream of the internal heat exchanger and upstream of the expansion valve, the medium-pressure bypass with the other expansion valve can consequently be connected to the circuit. Refrigerant that has already passed through the internal heat exchanger can then also be fed and expanded via the other expansion valve. The internal heat exchanger can also be connected in the medium-pressure bypass downstream of the other expansion valve. The refrigerant expanded at the other expansion valve flows through the internal heat exchanger, which is cooled as a result. Consequently, the internal heat exchanger in the medium-pressure side and thus the refrigerant in the high-pressure side of the internal heat exchanger are cooled. In principle, however, the medium-pressure bypass can also be connected to the cooling circuit in such a manner downstream of the gas cooler and upstream of the internal heat exchanger that the refrigerant then flows via the further expansion valve and the internal heat exchanger. Downstream of the internal heat exchanger, the medium-pressure bypass can be connected between the low-pressure compressor and the high-pressure compressor in such a manner that the refrigerant routed via the medium-pressure bypass can be mixed with the refrigerant circulating in the cooling circuit in this location. By using the medium-pressure bypass with the internal heat exchanger, it is possible, depending on the cooling load requirement of the control device, to divert refrigerant via the medium-pressure bypass so that less refrigerant flows via the expansion valve. At the same time, the refrigerant flowing via the medium-pressure bypass can be used to temperature-control the refrigerant on the high-pressure side by means of the internal heat exchanger. The very high volumetric cooling capacity of the carbon dioxides is thus diverted upstream of the heat exchanger and used for cooling the refrigerant on the high-pressure side when less cooling capacity is required in the test space. This also makes it possible for the test space to be smaller and for the cooling circuit operated with carbon dioxide to be used for more compact test chambers.

A medium-pressure side of the cooling circuit upstream of the high-pressure compressor and downstream of the low-pressure compressor can be connected to the gas cooler, and refrigerant can be routed from the low-pressure compressor to the high-pressure compressor via the gas cooler. This makes it possible to cool the refrigerant compressed and thus heated by the low-pressure compressor by means of the gas cooler before it reaches the high-pressure compressor. Since the gas cooler can be used to cool the refrigerant, an additional heat exchanger is not required.

Alternatively, a medium-pressure side of the cooling circuit can be connected to a medium-pressure cooler upstream of the high-pressure compressor and downstream of the compressor, and refrigerant can be routed from the low-pressure compressor to the high-pressure compressor via the medium-pressure cooler. The medium-pressure cooler can then be used specifically to cool the refrigerant compressed and thus heated by the low-pressure compressor before it reaches the high-pressure compressor.

The gas cooler and/or a medium-pressure cooler can be designed with air cooling or water cooling. Alternatively, an external cooling device can also be used to cool the gas cooler and/or the medium-pressure cooler.

The cooling circuit can be operated in a thermodynamically subcritical or transcritical operating state. Depending on the cooling load requirement within the test space, the operating state can be changed accordingly using the control device. In subcritical operation of the cooling circuit, the refrigerant is liquefied in the gas cooler below the critical point of the refrigerant and expanded at the expansion valve and converted to the gaseous phase or wet steam. The high-pressure compressor and the low-pressure compressor can be operated at least in the subcritical operating state. The subcritical operating state of the cooling circuit corresponds to partial load operation. In the transcritical operating state, the refrigerant circulates in the cooling circuit essentially in a gaseous state. This means that a difference in temperature is reduced to such an extent that the refrigerant is not liquefied in the gas cooler. Also, a pressure above the critical point of the refrigerant is reached at the gas cooler in the transcritical operating state. If there is a high cooling load requirement or cooling from +180° C. to −20° C. is required, for example, the cooling circuit can be operated transcritically. If there is a low cooling load requirement within the test space, for example if a temperature is to be kept constant, or if ambient temperatures are low, the cooling circuit can be operated subcritically. This allows an increase in efficiency to be achieved in particular in the case of low cooling load requirements in contrast to exclusively transcritical operating states. The change between the subcritical and the transcritical operating state is made possible in particular by the medium-pressure bypass and the internal heat exchanger.

Advantageously, pure carbon dioxide can be used as the refrigerant. Pure carbon dioxide has a GWP of 1, is non-flammable, non-hazardous and available at low cost. In addition, carbon dioxide is a pure substance or azeotropic, which is what makes the advantageous implementation of the method and its variations possible in the first place. A refrigerant with zeotropic behavior, on the other hand, would hardly make it possible to provide a sufficient quantity of gaseous refrigerant at a very low difference in temperature and thus hardly allow for performance control of the high-pressure compressor.

The temperature control device can be used to establish a temperature in a temperature range of −40° C. to +180° C., preferably from −50° C. to +180° C., particularly preferably from −55° C. to +180° C., within the test space.

The temperature control device can be used to establish a relative humidity in a range from 10% to 95%, preferably from 5% to 99%, at a temperature in a temperature range from +10° C. to +90° C., preferably from +5° C. to +98° C., within the test space.

The test chamber according to the invention, in particular a climate chamber, for conditioning air comprises a test space for receiving test material, the test space being configured to be sealed from an environment and temperature-insulated, and a temperature control device for controlling the temperature of the test space, the temperature control device being configured to establish a temperature in a temperature range of −20° C. to +180° C. within the test space, the temperature control device comprising a cooling device with a cooling circuit with carbon dioxide as a refrigerant, a heat exchanger in the test space, a low-pressure compressor and a high-pressure compressor, a gas cooler, and an expansion valve downstream of the low-pressure compressor in a flow direction of the refrigerant, the test chamber comprising a control device for controlling the temperature and/or the relative humidity in the test space, wherein the cooling circuit comprises a dehumidifier bypass having a second expansion valve and a second heat exchanger in the test space for dehumidifying air in the test space. Regarding the advantages of the test chamber according to the invention, reference is made to the description of advantages of the method according to the invention.

In comparable cooling circuits that are operated with carbon dioxide as a refrigerant, an additional valve including a throttle element is required in parallel to the expansion valve in order to be able to operate the cooling device in the specified temperature range. By using the dehumidifier bypass, this valve or the corresponding pipe section of the cooling circuit can be omitted, making the cooling circuit simpler to manufacture. An effective surface area of the heat exchanger for cooling the air in the test space is increased in this case, as a large part of the effective surface area of the heat exchanger can also be used to cool the air in the test space when the temperature control device is in air conditioning mode. By increasing the effective surface area of the heat exchanger, a smaller difference in temperature between the temperature of the heat exchanger and the temperature of the air in the test space is required in order to achieve a comparable cooling capacity. A cooling capacity (W) results from the product of a surface area (m²) of the heat exchanger, a heat transfer coefficient (W/m²*K) and a difference in temperature (K). A smaller difference in temperature in the case of a larger effective surface area of the heat exchanger has the effect that the accuracy of control can be improved because unwanted dehumidification, for example due to condensation on a cold surface of the heat exchanger when the temperature falls below the dew point, is reduced. A check valve can be disposed downstream of the second heat exchanger in the dehumidifier bypass. The check valve can be used to prevent refrigerant from moving against the flow direction into the second heat exchanger when the second expansion valve is closed.

The high-pressure compressor and the low-pressure compressor can share a compressor housing. In principle, the high-pressure compressor and the low-pressure compressor can also have two separate compressor housings. The use of the low-pressure compressor and the high-pressure compressor in the shared compressor housing significantly reduces the installation space required for the compressors. The compressors can be designed as rolling-piston compressors or as fully hermetic reciprocating-piston compressors in capsule format. Furthermore, an oil separator can be installed in the cooling circuit downstream of the high-pressure compressor. As a temperature of up to +180° C. can be reached in the test space, this temperature is then also transferred to the refrigerant contained therein via the heat exchanger. This can lead to a strong ageing process of the oil in the cooling circuit, which in turn can cause damage to the compressors. By means of the oil separator, the amount of oil inside the heat exchanger can be kept as low as possible so that only a small amount of oil is exposed to such high temperatures. This can further extend the service life of the compressors.

The heat exchanger and the second heat exchanger can have separate heat exchanger bodies or share a heat exchanger body. In this context, a heat exchanger body is understood here to be a body that can be composed of one or more parts, for example, and through which the refrigerant flows. This also includes line arrangements that are provided with fins for better heat transfer. The fins then form the heat exchanger body together with the line arrangement(s). The exchanger body then has a surface area effective for heat transfer.

The temperature control device can have a heating device with a heater and a heating heat exchanger in the test space. For example, the heating device can be an electrical resistance heater that heats the heating heat exchanger in such a manner that an increase in temperature in the test space is made possible via the heating heat exchanger. If the heat exchanger and the heating heat exchanger can be controlled in a targeted manner by means of the control device to cool or heat the air circulated in the test space, a temperature in the temperature ranges specified above can then be established within the test space by means of the temperature control device.

### BRIEF DESCRIPTION OF THE FIGURES

Hereinafter, a preferred embodiment of the invention is explained in more detail with reference to the accompanying drawings.

FIG. 1 is a schematic illustration of a first embodiment of a cooling device.

FIG. 2 is a schematic illustration of a second embodiment of a cooling device.

FIG. 3 is a schematic illustration of a third embodiment of a cooling device.

FIG. 4 is a schematic illustration of a fourth embodiment of a cooling device.

FIG. 5 is a schematic illustration of a fifth embodiment of a cooling device.

### DETAILED DESCRIPTION

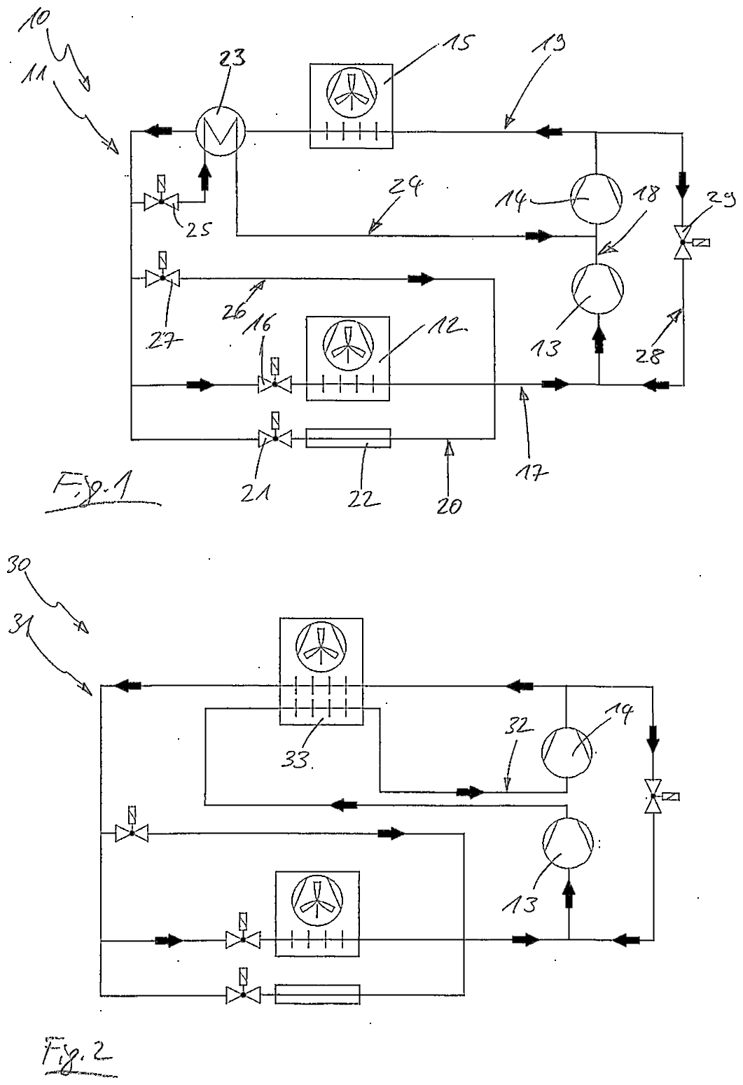

FIG. 1 shows a possible embodiment of a cooling device 10 of a test chamber (not shown). The cooling device 10 comprises a cooling circuit 11 with carbon dioxide (CO₂) as a refrigerant, a heat exchanger 12, a low-pressure compressor 13, a high-pressure compressor 14, a gas cooler 15, and an expansion valve 16. In the case at hand, the gas cooler 15 is configured in the manner of a heat exchanger or condenser and is cooled by a heat transfer medium, such as air or water. The heat exchanger 12 is disposed in an air treatment duct (not shown) of the test space of the test chamber in such a manner that air in the test space, which is circulated via the air treatment duct, can be cooled by means of the heat exchanger 12. Furthermore, the cooling circuit 11 has a low-pressure side 17, a medium-pressure side 18 and a high-pressure side 19. In the low-pressure side 17, the pressure of the refrigerant is comparatively lower than in the medium-pressure side 18. In the medium-pressure side 18, the pressure of the refrigerant is comparatively lower than in the high-pressure side 19.

Furthermore, a dehumidifier bypass 20 with a second expansion valve 21 and a second heat exchanger 22, which is also located in the test space, is disposed in the cooling circuit 11. Air in the test space can be dehumidified by means of the second heat exchanger 22 or the dehumidifier bypass 20. For this purpose, the test chamber has a control device (not shown) with which a temperature and/or a relative humidity in the test space can be controlled. To this end, the control device can actuate the expansion valve 16 and the second expansion valve 21 in particular. This makes it possible for the cooling device 10 to be used to carry out climatic tests in which dehumidification or relative humidity in the test space can be established very accurately even at a constant or falling temperature in the test space.

The cooling circuit 11 further has an internal heat exchanger 23 downstream in a flow direction of the refrigerant and a medium-pressure bypass 24 upstream of the expansion valve 16, the medium-pressure bypass 24 ending downstream of the low-pressure compressor 13 and upstream of the high-pressure compressor 14. Another expansion valve 25 is disposed in the medium-pressure bypass 24. The other expansion valve 25 is connected upstream of the internal heat exchanger 23. Essentially liquid refrigerant can now be fed from the gas cooler 15 through the high-pressure side 19 of the internal heat exchanger 23 and, if required, metered into the medium-pressure side 18 of the internal heat exchanger 23 via the other expansion valve 25. In this process, the refrigerant of the high-pressure side 19 is subcooled to such an extent that an even lower temperature can be established at the expansion valve 16 or the heat exchanger 12. At the same time, the refrigerant flowing via the medium-pressure bypass 24 can be used to keep the suction-gas temperature of the high-pressure compressor 14 comparatively low.

In addition, the cooling circuit 11 comprises a second bypass 26 with a third expansion valve 27. The second bypass 26 is connected to the cooling circuit 11 downstream of the internal heat exchanger 23 and upstream of the expansion valve 16 and downstream of the heat exchanger 14 and upstream of the low-pressure compressor 13 in the flow direction of the refrigerant. By means of the third expansion valve 27, liquid refrigerant can be fed to the low-pressure side 17 past the expansion valve 16 and the heat exchanger 12. This makes it possible to control a suction-gas temperature and/or a suction-gas pressure in the low-pressure side 17 upstream of the low-pressure compressor 13.

Furthermore, the cooling circuit 11 comprises another bypass 28 with another valve 29, the other bypass 28 being connected to the cooling circuit 11 downstream of the high-pressure compressor 14 and upstream of the gas cooler 15 and downstream of the heat exchanger 12 and upstream of the low-pressure compressor 13 in the flow direction of the refrigerant. By means of the other bypass 28 or the other valve 29, refrigerant, in particular superheated refrigerant or gaseous refrigerant, can be fed from the high-pressure side 19 to the low-pressure side 17 upstream of the low-pressure compressor 13 as a function of an operating state of the cooling circuit 11. This also makes it possible to control a suction-gas temperature and/or a suction-gas pressure of the low-pressure side 17 upstream of the low-pressure compressor 13. Said control can take place by means of the control device (not shown) of the test chamber and sensors located in the cooling circuit 11, in particular pressure and temperature sensors.

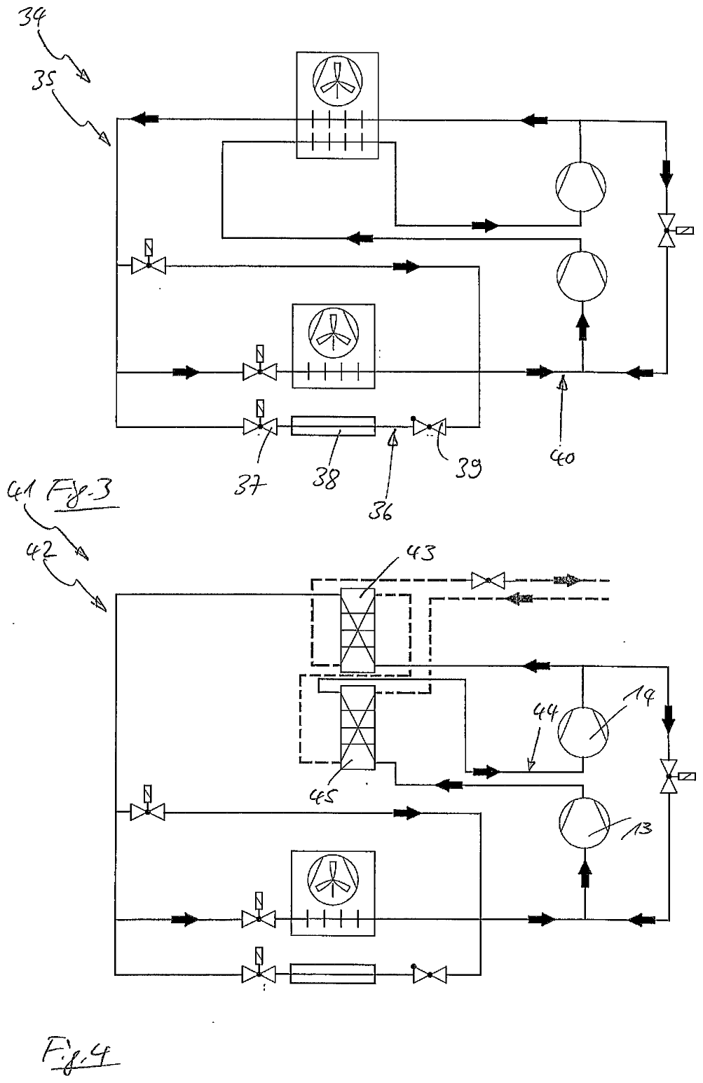

FIG. 2 shows a cooling device 30 with a cooling circuit 31, which differs from the cooling circuit of FIG. 1 in that a medium-pressure side 32 of the cooling circuit 31 is connected to a gas cooler 33 upstream of the high-pressure compressor 14 and downstream of the low-pressure compressor 13. In this manner, refrigerant can be fed from the low-pressure compressor 13 to the high-pressure compressor 14 via the gas cooler 33 and cooled there. So the cooling circuit 31 has no internal heat exchanger.

FIG. 3 shows a cooling device 34 with a cooling circuit 35, which differs from the cooling circuit of FIG. 2 in that a dehumidifier bypass 36 with a second expansion valve 37, a second heat exchanger 38, and a check valve 39 is formed. The check valve 39 is disposed downstream of the second heat exchanger 38 in the dehumidifier bypass 36 in a flow direction of the refrigerant. This prevents refrigerant of a low-pressure side 40 of the cooling circuit 31 next to the dehumidifier bypass 36 from flowing in against a regular flow direction and shifting into the second heat exchanger 28.

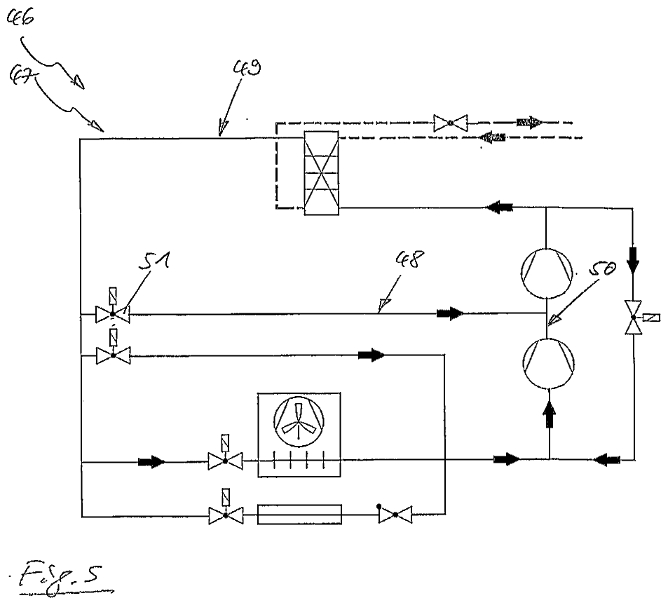

FIG. 4 shows a cooling device 41 with a cooling circuit 42, which differs from the cooling circuit of FIG. 3 in that a gas cooler 43 with water cooling is used. A medium-pressure side 44 is formed here with a medium-pressure cooler 45, which is also water-cooled. The medium-pressure cooler 45 is used to cool the refrigerant, which flows from the low-pressure compressor 13 to the high-pressure compressor 14 via the medium-pressure side 44.

FIG. 5 shows a cooling device 46 with a cooling circuit 47, cooling circuit 47 differing from the cooling circuit of FIG. 4 in that it has a medium-pressure bypass 48. The medium-pressure bypass 48 is connected to a high-pressure side 49 of the cooling circuit 47 downstream of the gas cooler 43 and upstream of the expansion valve 16 and to a medium-pressure side 50 of the cooling circuit 47 upstream of the high-pressure compressor 14 and downstream of the low-pressure compressor 13 in a flow direction of the refrigerant. By means of another expansion valve 51, refrigerant can be metered from the high-pressure side 49 into the medium-pressure side 50.

What is claimed is:

1. A method for conditioning air in a test space of a test chamber, in particular a climate chamber, for receiving test material, the test space being configured to be sealed from an environment and temperature-insulated, a cooling device of a temperature control device of the test chamber, which comprises a cooling circuit with carbon dioxide (CO₂) as a refrigerant, a heat exchanger in the test space, a low-pressure compressor, and a high-pressure compressor, a gas cooler, and an expansion valve downstream of the low-pressure compressor in a flow direction of the refrigerant, being used to establish a temperature in a temperature range of −20° C. to +180° C. within the test space, a control device of the test chamber being used to control the temperature and/or a relative humidity in the test space,
wherein a dehumidifier bypass of the cooling circuit, which comprises a second expansion valve and a second heat exchanger in the test space, is used to dehumidify air in the test space.

2. The method according to claim 1, wherein the dehumidifier bypass is connected to a high-pressure side of the cooling circuit downstream of the gas cooler and upstream of the expansion valve and to a low-pressure side of the cooling circuit downstream of the heat exchanger and upstream of the low-pressure compressor, refrigerant being metered from the high-pressure side into the low-pressure side via the second expansion valve in such a manner that the second heat exchanger is cooled.

3. The method according to claim 1, wherein a second bypass with at least a third expansion valve is formed in the cooling circuit, the second bypass being connected to a high-pressure side of the cooling circuit downstream of the gas cooler and upstream of the expansion valve and to a low-pressure side of the cooling circuit downstream of the heat exchanger and upstream of the low-pressure compressor, a suction-gas temperature and/or a suction-gas pressure of the refrigerant on the low-pressure side of the cooling circuit upstream of the low-pressure compressor being controlled by metering refrigerant into the low-pressure side via the third expansion valve.

4. The method according to claim 1, wherein another bypass having at least one other valve is formed in the cooling circuit, the other bypass being connected to a high-pressure side of the cooling circuit downstream of the high-pressure compressor and upstream of the gas cooler and to a low-pressure side of the cooling circuit downstream of the heat exchanger and upstream of the low-pressure compressor, a suction-gas temperature and/or a suction-gas pressure of the refrigerant on the low-pressure side of the cooling circuit upstream of the low-pressure compressor being controlled and/or a difference in pressure between the high-pressure side and the low-pressure side of the cooling circuit being equalized by metering refrigerant into the low-pressure side via the other valve.

5. The method according to claim 1, wherein a rotational speed of the high-pressure compressor and/or of the low-pressure compressor is controlled.

6. The method according to claim 1, wherein a suction-gas pressure in a low-pressure side of the cooling circuit is reduced while the temperature in the test space is being increased or kept constant, a difference in temperature between the second heat exchanger and the test space being increased.

7. The method according to claim 1, wherein a difference in temperature between the heat exchanger and the test space is increased in such a manner that air in the test space is dehumidified.

8. The method according to claim 1, wherein a suction-gas pressure in a low-pressure side of the cooling circuit is increased while the temperature in the test space is being lowered, a difference in temperature between the second heat exchanger and the test space being reduced.

9. The method according to claim 1, wherein the cooling circuit has a medium-pressure bypass connected to a high-pressure side of the cooling circuit downstream of the gas cooler and upstream of the expansion valve and to a medium-pressure side of the cooling circuit upstream of the high-pressure compressor and downstream of the low-pressure compressor, refrigerant being metered from the high-pressure side into the medium-pressure side via another expansion valve.

10. The method according to claim 1, wherein the cooling circuit has an internal heat exchanger connected to a high-pressure side of the cooling circuit downstream of the gas cooler and upstream of the expansion valve, the internal heat exchanger being coupled to a medium-pressure bypass of the cooling circuit, the medium-pressure bypass being connected to the high-pressure side downstream of the internal heat exchanger or the gas cooler and upstream of the expansion valve and to a medium-pressure side of the cooling circuit upstream of the high-pressure compressor and downstream of the low-pressure compressor, refrigerant being metered from the high-pressure side via the internal heat exchanger into the medium-pressure side by another expansion valve.

11. The method according to claim 1, wherein a medium-pressure side of the cooling circuit is connected to the gas cooler upstream of the high-pressure compressor and downstream of the low-pressure compressor, refrigerant being fed form the low-pressure compressor to the high-pressure compressor via the gas cooler.

12. The method according to claim 1, wherein a medium-pressure side of the cooling circuit is connected to a medium-pressure cooler upstream of the high-pressure compressor and downstream of the low-pressure compressor, refrigerant being fed from the low-pressure compressor to the high-pressure compressor via the medium-pressure cooler.

13. The method according to claim 1, wherein the cooling circuit is operated in a thermodynamically subcritical or transcritical operating state.

14. The method according to claim 1, wherein pure carbon dioxide (CO₂) is used as the refrigerant.

15. The method according to claim 1, wherein the temperature control device is used to establish a temperature in a temperature range of −40° C. to +180° C. within the test space.

16. The method according to claim 1, wherein the temperature control device is used to establish a relative humidity in a range of 10% to 95% at a temperature in a temperature range of +10° C. to +90° C. within the test space.

17. A test chamber, in particular a climate chamber, for conditioning air, the test chamber comprising a test space for receiving test material, the test space being configured to be sealed from an environment and temperature-insulated, and a temperature control device for controlling the temperature of the test space, the temperature control device being configured to establish a temperature in a temperature range of −20° C. to +180° C. within the test space, the temperature control device comprising a cooling device with a cooling circuit with carbon dioxide as a refrigerant, a heat exchanger in the test space, a low-pressure compressor, and a high-pressure compressor, a gas cooler, and an expansion valve downstream of the low-pressure compressor in a flow direction of the refrigerant, the test chamber comprising a control device for controlling the temperature and/or the relative humidity in the test space,
wherein the cooling circuit comprises a dehumidifier bypass having a second expansion valve and a second heat exchanger in the test space for dehumidifying air in the test space.

18. The test chamber according to claim 17, wherein a check valve is disposed in the dehumidifier bypass downstream of the second heat exchanger.

19. The test chamber according to claim 17, wherein the high-pressure compressor and the low-pressure compressor share a compressor housing.

20. The test chamber according to claim 17, wherein the heat exchanger and the second heat exchanger have separate exchanger bodies or share an exchanger body.

21. The test chamber according to claim 17, wherein the temperature control device comprises a heating device having a heater and a heating heat exchanger in the test space.
